(19) United States
(12) Patent Application Publication
(10) Pub. No.: US 2023/0206030 A1
(43) Pub. Date: Jun. 29, 2023

(54) HYPERPARAMETER NEURAL NETWORK ENSEMBLES

(71) Applicant: Google LLC, Mountain View, CA (US)

(72) Inventors: Rodolphe Jenatton, Berlin (DE); Florian Wenzel, Mountain View, CA (US); Dustin Tran, Mountain View, CA (US)

(21) Appl. No.: 18/008,404

(22) PCT Filed: Jun. 7, 2021
(86) PCT No.: PCT/US2021/036255

§ 371 Date: Dec. 5, 2022

Related U.S. Application Data
(60) Provisional application No. 63/035,614, filed on Jun. 5, 2020.

(51) Int. Cl. G06N 3/045; G06N 3/0985

(52) U.S. Cl. CPC G06N 3/045; G06N 3/0985

(57) ABSTRACT

Methods, systems, and apparatus, including computer programs encoded on computer storage media, for generating an ensemble of neural networks. In particular, the neural networks in the ensemble are trained using different hyperparameters from one another.

### CROSS-REFERENCE TO RELATED APPLICATION

This application claims priority to U.S. Provisional Application No. 63/035,614, filed Jun. 5, 2020, the entirety of which is herein incorporated.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates an ensemble of multiple neural networks to perform a particular machine learning task.

Particular embodiments of the subject matter described in this specification can be implemented so as to realize one or more of the following advantages.

Conventional techniques for generating ensembles of neural networks ensure diversity in the predictions generated by the neural networks in the ensemble by training the neural networks using different parameter initializations, i.e., by initializing the parameter values of the parameters of the neural networks in the ensemble to different initial values. The described techniques, however, vary both the initializations of the parameters and the hyperparameters used for the training of the neural networks. By using the described techniques to generate ensembles not only over weights but also over hyperparameters, the generated ensemble can outperform conventional ensembles, both with respect to accuracy of prediction generated by the ensemble and with respect to providing a measure for quantifying the uncertainty of the prediction generated by the ensemble.

Moreover, by generating computationally efficient batch ensembles in a manner that also ensures hyperparameter diversity among the generated batch ensembles, the described techniques can improve prediction quality and uncertainty quantification in a computationally efficient manner.

For example, in various example implementations, neural networks in the generated ensemble of K neural networks share at least some parameters. Since such shared parameters only need to be stored once even though they are used by multiple neural networks, the generated ensemble is thus adapted for memory-efficient storage. In particular, since parameters are shared between neural networks in the ensemble of K neural networks, the amount of memory required to store the ensemble of K neural networks can be the same or less than the memory that is available in a constrained memory space in which the ensemble of K neural networks are stored. Moreover, in some implementations where the K neural networks share parameters, the outputs of each of the K neural networks can be generated in parallel for an entire batch of multiple inputs, thereby decreasing the latency in generating a prediction for the ensemble relative to conventional techniques.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is a flow diagram of an example process for generating a hyper-deep ensemble.

FIG. 3 is a flow diagram of an example process for generating a hyper-batch ensemble.

FIG. 4 shows diagrams indicating the performance of hyper-deep ensembles and hyper-batch ensembles on various machine learning tasks.

Like reference numbers and designations in the various drawings indicate like elements.

### DETAILED DESCRIPTION

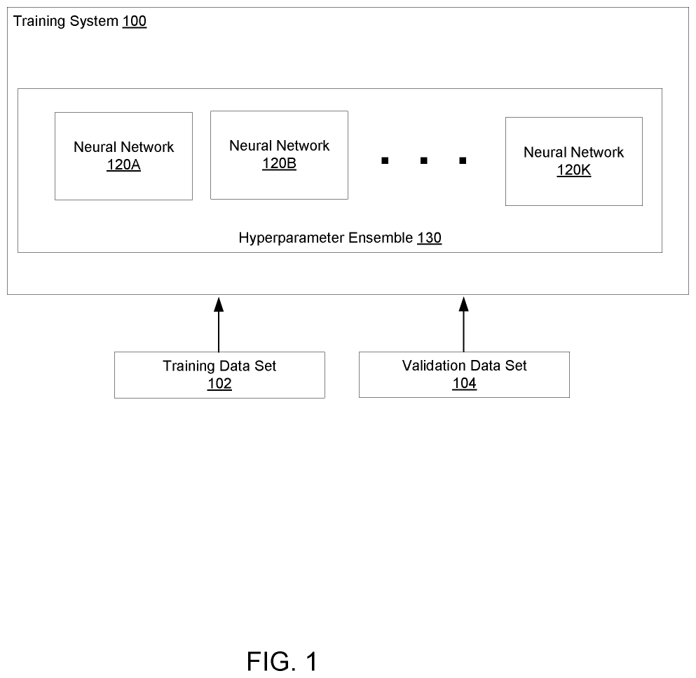

FIG. 1 shows an example training system 100. The training system 100 is an example of a system implemented as computer programs on one or more computers in one or more locations, in which the systems, components, and techniques described below can be implemented.

The training system 100 generates an ensemble 130 of multiple trained neural networks 120A-K that have been trained to perform a particular machine learning task using a training data set 102 and a validation data set 104.

The training data set 102 includes multiple training examples and, for each training example, a respective target output. The target output for a given training example is an output that should be generated by performing the particular machine learning task on the corresponding training input.

The validation data set 104 also includes multiple examples and, for each example, a respective target output, but will generally include different examples from those in the training data set 102. Examples in the validation data set 104 will also be referred to as “validation examples.”

Each neural network 120A-K in the ensemble 130 is configured to process a network input for the particular task and to generate an output for the particular task.

Because of the way that the system generates the ensemble 130 and trains the neural networks 120 in the ensemble 130, each trained neural network 120 in the ensemble 130 will generally have different parameter values from the other trained neural networks 120 in the ensemble 130. Thus, different ones of the neural networks 120A-K can generate different network outputs for different network inputs for the particular machine learning task.

The neural networks 120A-K in the ensemble 130 can be trained to perform any kind of machine learning task, i.e., can be configured to receive any kind of digital data input and to generate any kind of score, classification, or regression output based on the input.

In some cases, each neural network is a neural network that is configured to perform an image processing task, i.e., receive an input image and to process the input image, i.e., process the intensity values for the pixels of the input image, to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural networks are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural networks are features of an impression context for a particular advertisement, the output generated by the neural network may be a score that represents an estimated likelihood that the particular advertisement will be clicked on.

As another example, if the inputs to the neural networks are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural networks is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural networks is a sequence representing a spoken utterance, the output generated by the neural network may be a score for each of a set of pieces of text, each score representing an estimated likelihood that the piece of text is the correct transcript for the utterance. As another example, if the input to the neural networks is a sequence representing a spoken utterance, the output generated by the neural network can indicate whether a particular word or phrase (“hotword”) was spoken in the utterance. As another example, if the input to the neural networks is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

In particular, the system 100 generates the ensemble 130 of neural networks 120A-K in a manner that takes into account different hyperparameters of the training technique being used to train the neural networks. The ensemble 130 can therefore be referred to as a “hyperparameter ensemble” 130.

Hyperparameters are values or settings that, when modified, modify how the training technique operates. In other words, given a set of training data that includes multiple training examples and given current values of the parameters of a neural network, different hyperparameters will result in different updates being generated for the current values of the parameters as a result of performing the training technique on the training data set.

Examples of hyperparameters include weights for terms in a loss function, dropout rates for different layers of the neural network, hyperparameters of a regularization term, e.g., an L2 penalty, a label smoothing hyperparameter value that determines the amount of label smoothing to be applied to labels for training examples during the training, the learning rate value or learning rate decay value or other hyperparameters of the optimizer used by the training technique, the batch size, and so on.

The system 100 can generate the ensemble 130 in a manner that takes into account different hyperparameters of the training technique being used in any of several ways. In some implementations, the system 100 generates a pool of candidate trained neural networks that have each been trained using a different combination of hyperparameters and parameter initialization and then selects the ensemble 130 of neural networks from the pool of candidate trained neural network.

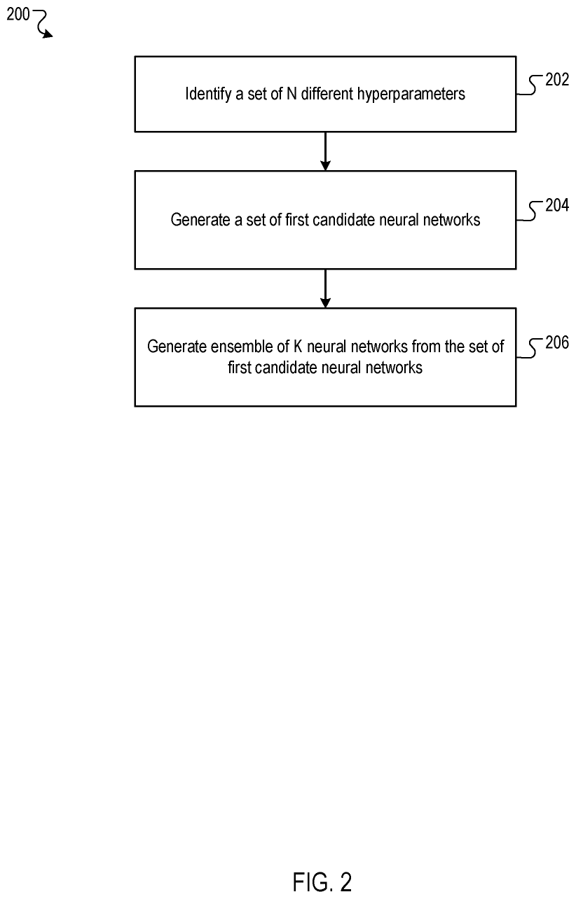

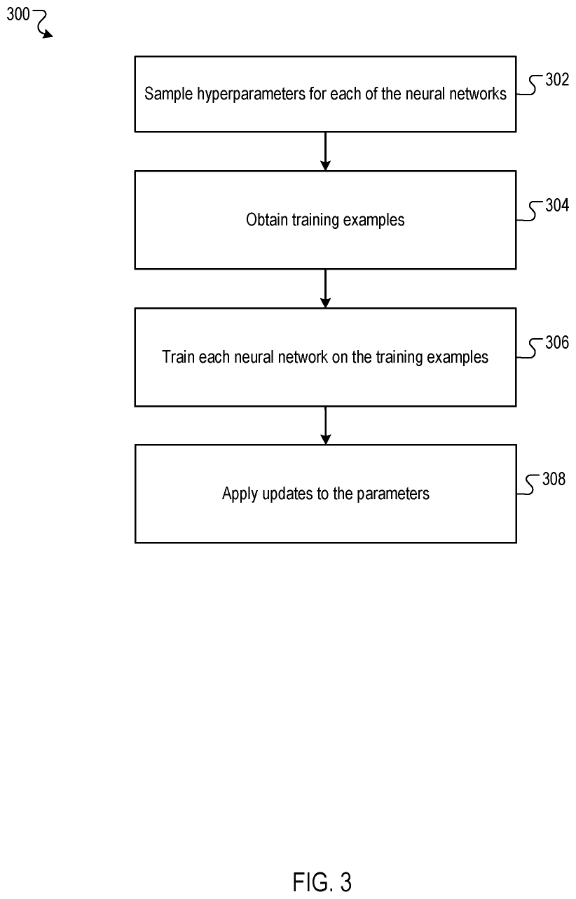

An ensemble 130 that is generated in this manner will be referred to as a hyper-deep ensemble. Generating a hyper-deep ensemble is described in more detail below with reference to FIGS. 2 and 3.

In some other implementations, the system 100 generates the ensemble 130 such that each of the neural networks 120A-K share some parameters among all of the neural networks 120A-K in the ensemble and each have some parameters that are not shared. To “share” a parameter between two neural networks means that the parameter takes the same value in both of the neural networks.

More specifically, in these implementations, each of the neural networks 120A-K has at least one “ensemble layer.” An ensemble layer is a layer that has (i) shared parameters that are the same values for all of the multiple neural networks 120A-K, (ii) specific parameters that are different values for different ones of the multiple neural networks 120A-K, and (iii) embedding parameters that include first embedding parameters that map current hyperparameters being used for the training of the neural network to a modification to the parameters of the layer.

As a particular example, for each neural network, the specific parameters for each ensemble layer in the neural network can include (i) first specific parameters that modify the shared parameters for the ensemble layer and (ii) second specific parameters that define a specific bias vector for the ensemble layer in the neural network.

In this example, to generate the final values of the parameters of the ensemble layer of a given one of the neural networks 120A-K at any given time during training, the system 100 applies a final modification to the shared parameters that is determined using the specific parameters for the given neural network and by applying the embedding parameters to the current hyperparameters being used for the training of the given neural network. The system 100 then uses the modified shared parameters that are generated by applying the final modification as the weights of the ensemble layer, e.g., as the weight matrix of a linear layer or the kernel of a convolutional layer, and the specific bias vector defined by the second specific parameters as the bias vector for the ensemble layer in the given neural network.

Additionally, in some cases, the embedding parameters further include second embedding parameters that map the current hyperparameters to a modifier for the specific bias vector.

Thus, in these examples, the system further applies the modifier generated from the second parameters and the current hyperparameters to the specific bias vector and uses the modified bias vector as the bias vector for the ensemble layer in the given neural network.

As a particular example, when the ensemble layer is a linear layer, the weight matrix Wₖ(λₖ) of the ensemble layer for a neural network kin the ensemble given current hyperparameters λₖ can satisfy:

Wₖ(λₖ)=W⊙(rₖsₖ^{T})+[Δ⊙(uₖvₖ^{T})]⊙e(λₖ)^{T},

where W and λ are shared kernels made up of shared weights, ⊙ denotes element-wise multiplication, rₖ, sₖ, uₖ, and vₖ are vectors of specific parameters that are specific to the neural network k, and e(λₖ) is an embedding of the current hyperparameters generated using the embedding parameters. For example, the embedding can be generated by applying a matrix of the embedding parameters to a vector of the current hyperparameters.

Additionally, when the linear layer has a bias term, the bias vector bₖ(λₖ) of the ensemble layer for a neural network k in the ensemble given the current hyperparameters can satisfy:

bₖ(λₖ)=bₖ+δₖ⊙e′(λₖ)^{T},

where bₖ and δₖ are bias terms that are specific to the neural network k, and e′(λₖ) is an embedding of the current hyperparameters generated using the second embedding parameters. For example, the embedding can be generated by applying a matrix of the second embedding parameters to a vector of the current hyperparameters.

Thus, to compute the output of the ensemble layer for the neural network k, the input to the layer is multiplied with the weight matrix Wₖ(λₖ) and the bias vector bₖ(λₖ) is added to the product.

As another particular example, when the ensemble layer is a convolutional layer, the kernel Kₖ(λₖ) of the ensemble layer for a neural network kin the ensemble given the current hyperparameters λₖ can satisfy:

Kₖ(λₖ)=K⊙(rₖsₖ^{T})+[Δ⊙(uₖvₖ^{T})]⊙e(λₖ)^{T},

where K and Δ are kernels made up of shared parameters.

Additionally, when the convolutional layer has a bias term, the bias term bₖ (λₖ) of the ensemble layer for a neural network k in the ensemble given the current hyperparameters λₖ can satisfy:

bₖ(λₖ)=bₖ+δₖ⊙e′(λₖ)^{T}.

In the two equations above, the rank-1 factors, i.e., rₖsₖ^{T} and uₖvₖ^{T}, should be understood as being broadcast along the height and width dimensions.

Thus, to compute the output of the ensemble layer for the neural network k, a convolution is performed between the kernel Wₖ(λₖ) and the input to the layer and the bias term bₖ(λₖ) is added to the output of the convolution.

Because the ensemble layers share a large number of parameters and because these shared parameters only need to be stored once for all of the K neural networks, the K neural networks will generally be much more computationally efficient, e.g., have a much smaller memory footprint, than an otherwise equivalent hyper-deep ensemble. Moreover, when the ensemble is used to process a batch of multiple neural network inputs, because of the structure of the ensemble layers, the network outputs for the batch for all of the K neural networks can be computed in parallel in one forward pass through a single “composite” neural network that represents all of the K neural neworks by tiling the neural network inputs in the batch before they are processed by the “composite” neural network.

In some cases, each layer within the K neural networks that has parameters is an ensemble layer, i.e., each linear layer and/or each convolutional layer is configured as an ensemble layer as described above. In some other cases, only a proper subset of the layers in the K neural networks that have parameters are ensemble layers, i.e., one or more linear layers, convolutional layers, or other type of neural network layer do not share any parameters between the K neural networks in the ensemble.

An ensemble 130 that is generated from K neural networks that have at least one ensemble layer will be referred to as a hyper-batch ensemble. Generating a hyper-batch ensemble is described in more detail below with reference to FIG. 3.

After the ensemble 130 is generated (and trained) by the system 100, the system 100 can use the ensemble 130 to process new network inputs to generate new network outputs for the machine learning task.

For example, the final output of the ensemble for a given new network input can be a measure of central tendency, e.g., the average or the average after one or more largest outliers have been removed, of the new network outputs generated by the networks 120A-K in the ensemble 130 for a given network input. Using the output of the ensemble 130 instead of the output of a single network can result in outputs that have improved accuracy on the machine learning task.

In addition to generating the final output, the outputs of the networks 120A-K in the ensemble 130 can also be used to generate a measure of uncertainty of the accuracy of the final output, e.g., as a measure of the variability of the outputs of the individual networks in the ensemble. The measure of variability can be, e.g., an entropy-based measure of variability. As one example, the measure can be equal to the sum of, for each neural network, the Kullback-Leibler (KL) divergence between the network output generated by the neural network and the final output. As another example, the measure can be equal to the difference between the entropy of the final output and the average of the entropies of the individual network outputs generated by the neural networks in the ensemble. Alternatively, for classification tasks, the measure of variability can be computed based on a direct comparison of the scores assigned to a predetermined subset of the categories over which the network output is computed. For example, the measure of variability can be computed as the difference between the largest score computed for any category in the subset by any of the ensembles and the smallest score computed for any category in the subset by any of the ensembles.

In more detail, after generating the ensemble 130, i.e., after training each of the neural networks 120A-K and, for hyper-deep ensembles, selecting the neural networks 120A-K to be included in the ensemble, the system 100 can receive a new network input and process the new network input using each of the K neural networks 120A-K in the ensemble 130 to generate K new network outputs for the new network input.

The system can then generate a final new network output for the new network input from the K new network outputs, e.g., as a measure of central tendency of the K new network outputs.

The system can also generate, from the K new network outputs, a measure of uncertainty of the accuracy of the final new network output.

When the ensemble is a hyper-batch ensemble, in order to process the new network input using each of the K neural networks in the ensemble, the system determines, for each of the K neural networks, respective hyperparameters and, for each ensemble layer in the K neural networks, applies the embedding parameters for the neural network to the determined hyperparameters to generate the modifier for the shared parameters and then uses the modified shared parameters as described above. Determining hyperparameters after training will be described below with reference to FIG. 3.

FIG. 2 is a flow diagram of an example process 200 for generating a hyper-batch ensemble. For convenience, the process 200 will be described as being performed by a system of one or more computers located in one or more locations. For example, a training system, e.g., training system 100 of FIG. 1, appropriately programmed in accordance with this specification, can perform the process 200.

In particular, the system performs the process 200 to generate an ensemble of K neural networks to perform a machine learning task, where K is a fixed integer greater than one.

The system identifies a set of N different hyperparameters for training a neural network having parameters to perform the machine learning task (step 202). Like K, N is an integer greater than one and can be equal to K or can be an integer that is greater than K.

In some implementations, to identify the set of N different hyperparameters, the system applies a hyperparameter search technique to identify the M best-performing hyperparameters for the machine learning task, where M is an integer that is greater than N.

The system can apply any appropriate hyperparameter search technique that is used to search for an optimal set of hyperparameters. As a particular example, the system can use random search and select the M best-performing hyperparameters that were evaluated as part of the random search technique. Other examples of hyperparameter search techniques that can be used include grid search and automated hyperparameter tuning techniques, e.g., a hyperparameter tuning technique based on Bayesian optimization.

The system then selects, from the M best-performing hyperparameters, N hyperparameters using an ensemble selection technique.

As a particular example, the system can generate a set of M second candidate neural networks that have each been trained using a different one of the M best-performing hyperparameters. That is, the system can train, on the same training data set or on respective portions of a larger training data set, a respective neural network using each of the M best-performing hyperparameters to generate the set of M second candidate neural networks.

The system then generates, from the M second candidate neural networks, a first ensemble of N candidate neural networks by repeatedly adding to the first ensemble, i.e., by adding a new candidate neural network at each of multiple iterations. At each iteration, the system can select, from the M candidate neural networks, the candidate neural network that, if added to the first ensemble, would result in the largest increase in performance of the first ensemble on the machine learning task. The system can measure the performance of an ensemble on the machine learning task as the performance of the ensemble on a plurality of validation examples from a validation data set for the machine learning task using an appropriate performance measure of the final outputs of the ensemble, e.g., the average negative log likelihood of the final outputs generated by the ensemble for the plurality of validation examples.

The system then selects, as the N hyperparameters, the hyperparameters used to train the N candidate neural networks in the first ensemble.

The system generates a set of first candidate trained neural networks (step 204).

To generate the set of first candidate trained neural networks, the system can train a set of multiple neural networks for each of the N different hyperparameters.

In particular, for each of the N different hyperparameters, the system can select a plurality of different initializations for values of the parameters of the neural network. For example, the system can select a fixed number of different initializations by, for each initialization, applying an appropriate random parameter initialization scheme to each parameter of the neural network. For example, the system can generate an independent sample from a given probability distribution, e.g., a Gaussian distribution, for each initialization. As another example, the system can generate an independent sample from a distribution that assigns a positive sign to the parameter with one probability and a negative sign with another probability. That is, each different initialization is a different random initialization of values of the parameters of the neural network.

For each of the N different hyperparameters and for each of the different initializations, the system can train a corresponding neural network with (i) the different hyperparameters and (ii) parameter values initialized using the different initialization to generate a trained neural network.

By doing this for each of the N different hyperparameters, the resulting set of first candidate trained neural networks includes multiple different neural networks that were trained using different combinations of parameter initializations and hyperparameters.

The system generates the ensemble of K neural networks by selecting K neural networks from the first candidate trained neural networks (step 206).

In particular, the system can generate the ensemble using an ensemble generation technique that is the same as or different from the ensemble generation technique that was used to select the N hyperparameters.

As a particular example, the system can generate, from the set of first candidate trained neural networks, the ensemble of K neural networks by adding a new first candidate trained neural network to the ensemble at each of multiple iterations.

At each iteration, the system can add a first candidate trained neural network to the ensemble by selecting, from the first candidate trained neural networks in the set, the neural network that, if added to the ensemble, would result in the largest increase in performance of the ensemble of any of the neural networks in the ensemble.

In some cases, the system performs this iterative selection without replacement, i.e., once a given candidate is added to the ensemble, it is removed from the pool of available candidates at subsequent iterations.

In some other cases, the system performs this iterative selection without replacement, i.e., once a given candidate is added to the ensemble, it is not removed from the pool of available candidates at subsequent iterations and is available to be added to the ensemble again at later iterations. In these cases, the system can continue performing iterations until either K unique neural networks have been added to the ensemble or until K total neural networks have been added to the ensemble (even if some of the K are different instances of the same neural network). Because the final output is computed as a measure of central tendency, the final output will weight outputs generated by neural networks that have more than one instance in the ensemble more strongly than those that have only one instance in the ensemble.

FIG. 3 is a flow diagram of an example process 300 for generating a hyper-deep ensemble. For convenience, the process 300 will be described as being performed by a system of one or more computers located in one or more locations. For example, a training system, e.g., training system 100 of FIG. 1, appropriately programmed in accordance with this specification, can perform the process 300.

In particular, the system performs the process 300 to train an ensemble having K neural networks each configured to perform the machine learning task.

Each of the K neural networks has a plurality of neural network layers having respective parameters, with at least one of those layers being an ensemble layer that, for each of the K neural networks has: (i) shared parameters that are shared between all of the K neural networks in the ensemble, (ii) specific parameters that are specific to the neural network, and (iii) embedding parameters that include first embedding parameters that map current hyperparameters to a modifier for the shared parameters.

In some cases, the embedding parameters are specific to the neural network while in other cases, the embedding parameters are shared between the neural networks in the ensemble.

Additionally, in some cases, each ensemble layer also includes second embedding parameters that map current hyperparameters to a modifier for the bias of the ensemble layer.

The operation of an ensemble layer is described above with reference to FIG. 1.

During the training of neural networks in the ensemble, each of the K neural networks is trained with hyperparameters repeatedly sampled from a different distribution than the other K neural networks. That is, during the training, the system maintains, for each of the K neural networks, a respective set of hyperparameter distribution parameters that define a distribution over hyperparameters for the training of the neural network.

In particular, each hyperparameter distribution defines a distribution over possible values of each hyperparameter of the training that will be varied between the different neural networks in the ensemble. For example, each neural network can be trained with the same batch size, while the dropout rate, the regularization rate, or both can be varied between different neural networks in the ensemble.

As a particular example, the system can represent a given set of hyperparameters that includes a respective value for each hyperparameter that can be varied as a multi-dimensional vector. For each neural network, the hyperparameter distribution can be represented as multiple independent distributions, e.g., one per dimension in the multi-dimensional vector. The hyperparameter distribution parameters then define each independent distribution. For example, each distribution can be a log-uniform distribution and the hyperparameter distribution parameters can include two parameters for each dimension that define the bounds of the ranges of the corresponding log-uniform distribution.

The system then trains the K neural networks by repeatedly performing the process 300 on different sets of training examples using the maintained data.

The system samples, for each of the K neural networks, hyperparameters from the distribution defined by the respective set of hyperparameter distribution parameters for the neural network (step 302). For example, for a given neural network, the system can sample a respective value for each dimension of the multi-dimensional vector from the independent distribution for that dimension for the given neural network.

The system obtains a plurality of training examples for the machine learning task (step 304). For example, the system can sample a mini-batch of multiple training examples from a set of training data for the machine learning task. The training data can include multiple training examples and, for each of the training examples, a respective target output, i.e., an output that should be generated by a neural network by performing the machine learning task on the corresponding training example.

For each of the K neural networks, the system trains the neural network on the plurality of training examples in accordance with the sampled hyperparameters for the neural network to determine updates to at least the shared parameters, the specific parameters, and the embedding parameters of the first neural network layer (step 306).

In some implementations, the system trains each of the neural networks to minimize a loss function that measures, for each neural network, a loss between a network output generated by the neural network for a given training example and a target output for the given training example. The loss between an output and a target output can be of any form that is appropriate for the machine learning task, e.g., a cross-entropy loss or a negative log likelihood loss. That is, in these implementations, the loss function includes a respective loss term for each of the K neural networks that measures the loss between the network output generated by the neural network for a given training example and a target output for the given training example. For example, the loss function can measure the average of the losses for the plurality of training examples.

In some other implementations, the system trains each of the neural networks to minimize a loss function that measures a loss between a final output generated from network outputs generated by the K neural networks for a given training example and a target output for the given training example. As described above, the final output for a given training example can be a measure of central tendency of the network outputs generated by the K neural networks.

In either of these implementations, the loss function can also include one or more additional terms, e.g., regularization terms or auxiliary loss terms or both, in addition to the term(s) that measure(s) the loss between the output and the target output.

In order to perform the training of a given neural network, for each ensemble layer, the system applies the first embedding parameters to the sampled hyperparameters for the given neural network to generate the modifier for the shared parameters and processes inputs to the given neural network in accordance with the modified shared parameters as described above. When included, the system also applies the second embedding parameters to the sampled hyperparameters for the given neural network generate the modifier for the bias term for the ensemble layer.

To determine the update, the system computes, e.g., through backpropagation, a respective gradient of the loss function with respect to, for each ensemble layer, the shared parameters and the embedding parameters of the ensemble layer and, for each neural network, respective gradients with respect to the specific parameters of the ensemble layer for that neural network. The system then maps the gradients to updates using an appropriate optimizer, e.g., Adam, rmsProp, Adafactor, SGD, and so on.

Similarly, the system also computes an update for the remaining parameters of the neural networks in the ensemble, i.e., the update for any layers that are not ensemble layers within any of the neural networks, by computing a gradient of the loss function with respect to those parameters.

The system then applies, to the shared parameters, the updates determined for each of the K neural networks (step 308). For each of the K neural networks, the system also applies the updates to the specific parameters for the first neural network layer of the neural network. Thus, a single, shared update is applied to the shared parameters while different, neural network-specific updates are applied to the specific parameters for each neural network.

In addition to updating the parameters, the system can also update the hyperparameter distributions for each of the neural networks at each iteration of the process 300.

In particular, the system can obtain a plurality of validation examples and update the respective sets of hyperparameter distribution parameters based on a performance of the K neural networks on the validation examples.

In particular, the system can compute a gradient with respect to the hyperparameter distribution parameters of each neural network of a validation loss function that (i) measures, for each neural network, a loss between a network output generated by the neural network for a given validation example in the validation examples and a target output for the given validation example or (ii) measures a loss between a final output generated from network outputs generated by the K neural networks for a given validation example and a target output for the given validation example.

In some cases, the validation loss function also includes a term that measures the entropy of the hyperparameter distributions as defined by the current hyperparameter distribution parameters, i.e., the entropy of an overall distribution generated by combining the hyperparameter distributions for all of the neural networks in the ensemble. Including this entropy term can encourage diversity in the probability distributions of the neural networks in the ensemble.

As described above, after training, the system needs to select respective hyperparameters for each neural network in the ensemble in order to generate outputs for new inputs. As a particular example, after the training has completed, the system can, for each of the K neural networks, fix the hyperparameters by selecting the hyperparameters using the probability distribution defined by the hyperparameter distribution parameters as of the end of the training process. More specifically, the system can select, for any given neural network, the value of each dimension of the multi-dimensional vector to be the mean of the distribution for the dimension as defined by the final distribution parameters after training.

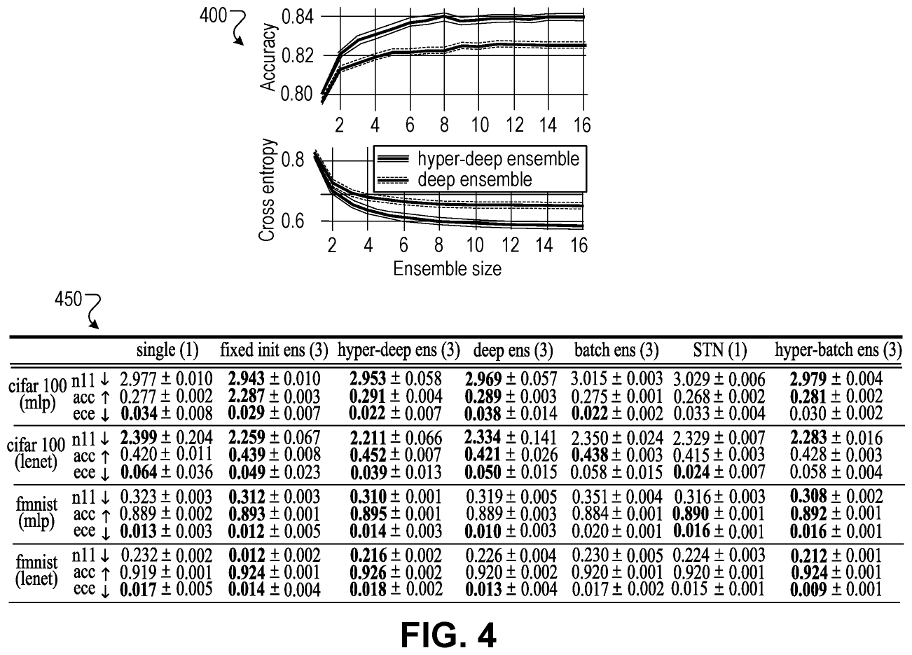

FIG. 4 shows diagrams 400 and 450 indicating the performance of hyper-deep ensembles and hyper-batch ensembles on various machine learning tasks.

In particular, diagram 400 shows the performance of hyper-deep ensembles that are configured to perform image classification and trained on the CIFAR-100 data set relative to a baseline technique, referred to as “deep ensemble,” where all ensembles in the batch are trained using the same hyperparameters. As can be seen from the diagram, hyper-deep ensembles outperform deep ensembles at a range of different ensemble sizes, where the size of an ensemble is the number of neural networks in the ensemble.

Diagram 450 shows the performance of a single neural network, two baseline deep ensemble-based techniques (a fixed init ensemble and a deep ensemble), a hyper-deep ensemble, two baseline techniques that are known to be computationally efficient (a batch ensemble, a self-tuning network) and a hyper-batch ensemble on two image classification tasks: one trained on the CIFAR-100 data set and the other on the fashion MNIST data set. Diagram 450 also shows results for two different neural network architectures: a multi-layer perceptron (MLP) and a LeNet. That is, diagram 450 shows results where each neural network is an MLP and results where each neural network is a LeNet. The MLP can include multiple linear hidden layers that are optionally separated with non-linear activation function layers and further optionally include a dropout layer before the last layer of the neural network. A LeNet is a convolutional neural network that is made up of a first two-dimensional convolutional layer with a max-pooling operation followed by a two-dimensional convolutional layer with a max-pooling operation and finally followed by two dense layers. An activation function can be applied after each convolutional layer. Moreover, a dropout layer can be included before the last dense layer.

As can be seen from the diagram 450, the hyper-deep ensemble generally outperforms the baseline deep ensemble-based techniques while the hyper-batch ensemble generally outperforms the baseline computationally-efficient techniques on various performance measures—negative log likelihood (“nll”), classification accuracy (“acc”), and expected calibration error (“ece”).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of training an ensemble comprising K neural networks to perform a machine learning task, wherein K is an integer greater than one,
wherein each of the K neural networks comprises a plurality of neural network layers having respective parameters,
wherein the plurality of neural network layers includes a first neural network layer that, for each of the K neural networks, has:
(i) shared parameters that are shared between all of the K neural networks in the ensemble,
(ii) specific parameters that are specific to the neural network, and
(iii) embedding parameters that include first embedding parameters that map current hyperparameters to a modifier for the shared parameters;
wherein the method comprises:
maintaining, for each of the K neural networks, a respective set of hyperparameter distribution parameters that define a distribution over hyperparameters for the training of the neural network; and
training the K neural networks by repeatedly performing the following operations:
sampling, for each of the K neural networks, hyperparameters from the distribution defined by the respective set of hyperparameter distribution parameters for the neural network;
obtaining a plurality of training examples;
for each of the K neural networks, training the neural network on the plurality of training examples in accordance with the sampled hyperparameters for the neural network to determine updates to at least the shared parameters, the specific parameters, and the embedding parameters of the first neural network layer; and
applying, to the shared parameters, the updates determined for each of the K neural networks.

2. The method of claim 1, wherein the embedding parameters are shared between the neural networks in the ensemble.

3. The method of claim 1, the operations further comprising:
for each of the K neural networks, applying the updates to the specific parameters for the first neural network layer of the neural network.

4. The method of claim 1, wherein training each of the neural networks on the training examples comprises training each of the neural networks to minimize a loss function that measures, for each neural network, a loss between a network output generated by the neural network for a given training example and a target output for the given training example.

5. The method of claim 1, wherein training each of the neural networks on the training examples comprises training each of the neural networks to minimize a loss function that measures a loss between a final output generated from network outputs generated by the K neural networks for a given training example and a target output for the given training example.

6. The method of claim 1, wherein for each of the K neural networks, training the neural network on the plurality of training examples in accordance with the sampled hyperparameters comprises applying the embedding parameters to the sampled hyperparameters to generate the modifier for the shared parameters.

7. The method of claim 1, the operations further comprising:
obtaining a plurality of validation examples; and
updating the respective sets of hyperparameter distribution parameters based on a performance of the K neural networks on the validation examples.

8. The method of claim 1, wherein the specific parameters include first specific parameters that modify the shared parameters and second specific parameters that define a specific bias vector for the first neural network layer.

9. The method of claim 8, wherein the embedding parameters further include second embedding parameters that map current hyperparameters to a modifier for the specific bias vector.

10. A method of training an ensemble comprising K neural networks to perform a machine learning task, wherein K is an integer greater than one, and wherein the method comprises:
identifying a set of N different hyperparameters for training a neural network having parameters to perform the machine learning task, wherein N is an integer greater than one;
generating a set of first candidate trained neural networks by, for each of the N different hyperparameters:
selecting a plurality of different initializations for values of the parameters of the neural network; and
for each of the different initializations, training a corresponding neural network with (i) the different hyperparameters and (ii) parameter values initialized using the different initialization to generate a trained neural network; and
generating the ensemble of K neural networks by selecting K neural networks from the first candidate trained neural networks.

11. The method of claim 10, wherein identifying a set of N different hyperparameters for training a neural network in the ensemble comprises:
applying a hyperparameter search technique to identify M best-performing hyperparameters for the machine learning task, wherein M is an integer that is greater than N; and
selecting, from the M best-performing hyperparameters, N hyperparameters using a first ensemble selection technique.

12. The method of claim 11, wherein N is equal to K.

13. The method of claim 1, wherein the hyperparameter search technique is random search.

14. The method of claim 1, wherein selecting the N hyperparameters using the ensemble selection technique comprises:
generating a set of M second candidate neural networks that have each been trained using a different one of the M best-performing hyperparameters;
generating, from the M second candidate neural networks, a first ensemble of N candidate neural networks by repeatedly adding to the first ensemble by selecting from the M candidate neural networks the candidate neural network that, if added to the first ensemble, would result in a largest increase in performance of the first ensemble; and
selecting, as the N hyperparameters, the hyperparameters used to train the N candidate neural networks in the first ensemble.

15. The method of claim 10, wherein generating the ensemble of K neural networks comprises generating the ensemble using a second ensemble generation technique.

16. The method of claim 15, wherein generating the ensemble of K neural networks comprises:
generating, from the set of first candidate trained neural networks, the ensemble of K neural networks by repeatedly adding a first candidate trained neural network to the ensemble by selecting from the set of first candidate trained neural networks, the first candidate trained neural network that, if added to the ensemble, would result in a largest increase in performance of the ensemble.

17. The method of claim 10, wherein the different initializations for the parameters of the neural network are different random initializations of values of the parameters of the neural network.

18. The method of claim 1, further comprising, after the training of the ensemble:
receiving a new network input;
processing the new network input using each of the K neural networks in the ensemble to generate K new network outputs for the new network input; and
generating a final new network output for the new network input from the K new network outputs.

19. The method of claim 18, further comprising:
generating, from the K new network outputs, a measure of uncertainty of an accuracy of the final new network output.

20. The method of claim 18, wherein processing the new network input using each of the K neural networks in the ensemble to generate K new network outputs for the new network input comprises:
for each of the K neural networks, determining hyperparameters based on the respective set of hyperparameter distribution parameters for the neural network after the training has completed and applying the embedding parameters for the neural network to the determined hyperparameters.

21. The method of claim 1, wherein the machine learning task comprises image classification, image embedding generation, object detection, image segmentation, speech recognition, text to speech, or a real-world agent control task.

22. A system comprising one or more computers and one or more storage devices storing instructions that when executed by the one or more computers cause the one or more computers to perform operations for training an ensemble comprising K neural networks to perform a machine learning task, wherein K is an integer greater than one,
wherein each of the K neural networks comprises a plurality of neural network, layers having respective parameters,
wherein the plurality of neural network layers includes a first neural network layer that for each of the K neural networks, has:
(i) shared parameters that are shared between ail of the K neural networks in the ensemble,
(ii) specific parameters that, are specific to the neural network, and
(iii) embedding parameters that include first embedding parameters that map current hyperparameters to a modifier for the shared parameters;
wherein the operations comprise:
maintaining, for each of the K neural networks, a respective set of hyperparameter distribution parameters that define a distribution over hyperparameters for the training of the neural network; and
training the K neural networks by repeatedly performing the following operations:
sampling for each of the K neural networks, hyperparameters from the distribution defined by the respective set of hyperparameters distribution parameters for the neural network;
obtaining a plurality of training examples;
training examples in accordance with the sampled hyperparameters for the neural network to determine updates to at least the shared parameters, the specific parameters, and the embedding parameters of the first neural network layer; and
applying, to the shared parameters, the updates determined for each of the K neural networks.

23. (canceled)
